(19) United States
(12) Patent Application Publication
(10) Pub. No.: US 2025/0284722 A1
(43) Pub. Date: Sep. 11, 2025

(54) VERIFYING QUERIES USING NEURAL NETWORKS

(71) Applicant: GDM Holding LLC, Mountain View, CA (US)

(72) Inventors: Kenneth Daniel Marino, Jersey City, NJ (US); Manzil Zaheer, Mountain View, CA (US); Ishita Dasgupta, Brooklyn, NY (US); Kavya Venkata Kota Sai Kopparapu, New York, NY (US); John Henry Schultz, Brooklyn, NY (US); Robert David Fergus, New York, NY (US)

(21) Appl. No.: 19/074,205

(22) Filed: Mar. 7, 2025

Related U.S. Application Data
(60) Provisional application No. 63/562,610, filed on Mar. 7, 2024.

(51) Int. Cl. G06F 16/334; G06F 16/3329

(52) U.S. Cl. CPC G06F 16/3344; G06F 16/3329

(57) ABSTRACT

Methods, systems, and apparatus, including computer programs encoded on a computer storage medium, for predicting whether a given query is valid. One of the methods includes receiving a query comprising natural language text for verification; obtaining, from a set of text segments, a subset of relevant text segments that are relevant to the query; obtaining, from a current set of verified statements, a subset of relevant verified statements that are relevant to the query; generating, using a query verifier machine learning model, a prediction of whether the query is valid given the relevant text segments and the relevant verified statements; and determining whether to update the current set of verified statements to include the query based on the prediction of whether the query is valid.

### CROSS-REFERENCE TO RELATED APPLICATION

This application claims priority to U.S. Provisional Application No. 63/562,610, filed on Mar. 7, 2024. The disclosure of the prior application is considered part of and is incorporated by reference in the disclosure of this application.

### BACKGROUND

This specification relates to processing inputs using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a system implemented as computer programs on one or more computers in one or more locations that uses neural networks to predict whether a given query is valid.

A valid query includes a statement that is factually true. Predicting whether a given query is valid can include predicting whether the given query is factually true. A verified query or verified statement can include a query or statement that was predicted to be factually true.

The subject matter described in this specification can be implemented in particular embodiments so as to realize one or more of the following advantages.

The system described in this specification can verify whether a given query is valid with greater accuracy than conventional systems. The system can predict whether queries are valid or invalid, allowing for more accurate reasoning, decisionmaking, and research based on verified queries. As the system verifies more queries as valid, the system increases the number of verified statements that can be used as conditioning for subsequent queries, allowing for continual learning. For example, the system can generate a prediction of whether the given query is valid using a query verifier machine learning model given relevant verified statements from a current set of verified statements. If the system determines that the given query is valid, the system can update the current set of verified statements to include the given query. The system can thus generate more accurate predictions for verification of subsequent queries given the updated current set of verified statements.

Users may use collections of information such as the Internet to find specific information about the world. However, not all information on the Internet may be factually true. The system can be used to automate fact-checking over large collections of information. For example, the system can automate the validation of statements, such as narratives and opinions shared on the Internet. The system can iterate over available knowledge to refine its ability to verify whether a given query is valid. The system can thus perform more precise and automated fact-checking, saving computing time and resources compared to manual fact-checking over large collections of information.

The system can provide for the performance of tasks using verified statements. For example, the system can further process one or more verified statements of the current set of verified statements using a language model neural network to perform tasks, e.g., reasoning tasks, based on the verified statements.

In some implementations, the system can automate the identification of statements, e.g., from the Internet, for verification. For example, the system can generate the initial current set of verified statements. For example, the system can process a set of text segments to determine multiple statements in the set of text segments. The system can predict whether each of the multiple statements is valid using the query verifier machine learning model. Rather than requiring a manually verified set of statements, the system can automate the generation of an accurate current set of verified statements for use in predicting whether queries are valid. The system can also update the current set of verified statements to include queries if the system determines the queries are valid, providing for a larger set of verified statements for use in predicting whether subsequent queries are valid.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A shows an example system for verifying queries.

FIG. 1B shows an example query verification machine learning model.

FIG. 2 is a flow diagram of an example process for generating a prediction of whether a query is valid.

FIGS. 3A-3B show a flow diagram of an example process for determining a current set of verified statements.

FIG. 4 shows an example independent model.

FIG. 5 shows the performance of an example system for verifying queries.

Like reference numbers and designations in the various drawings indicate like elements.

### DETAILED DESCRIPTION

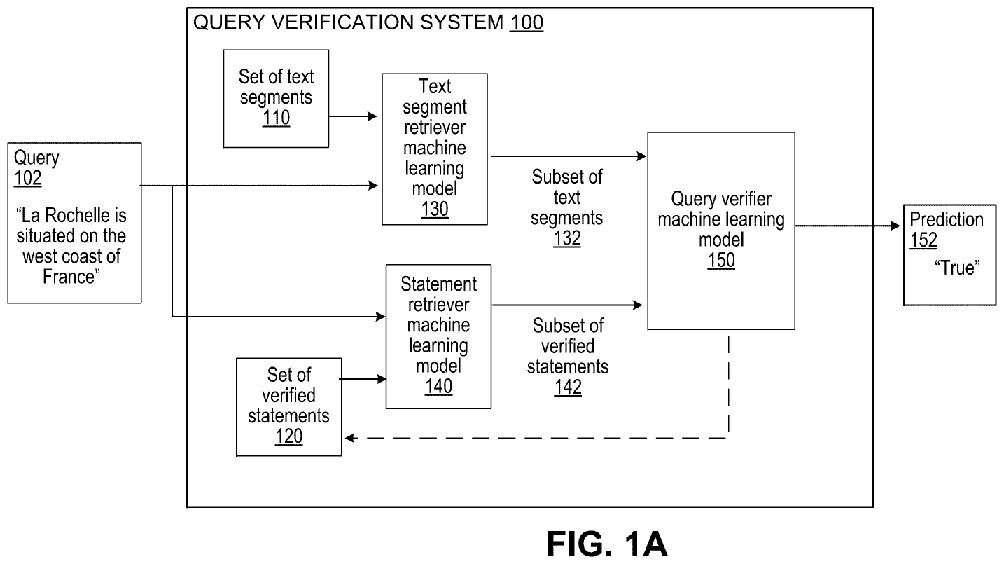

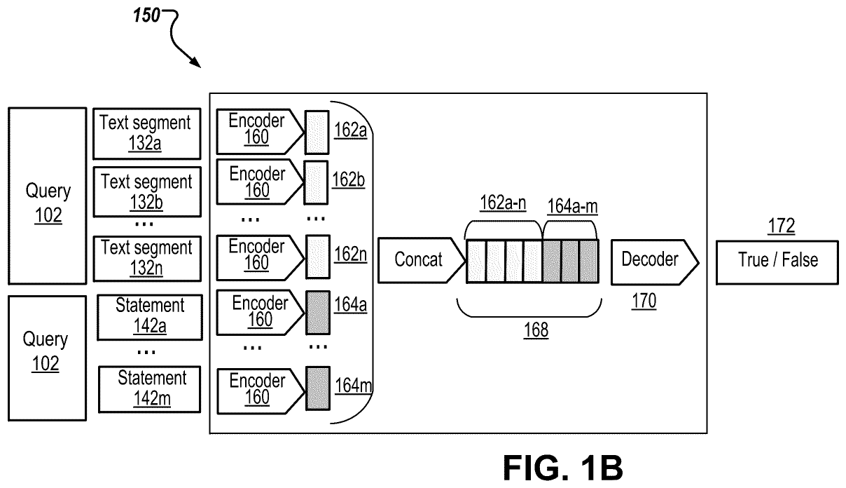

FIG. 1A shows an example query verification system 100. The system 100 is an example of a system implemented as computer programs on one or more computers in one or more locations in which the systems, components, and techniques described below are implemented.

The system 100 generates a prediction 152 of whether a given query 102 is valid. In some examples, the prediction 152 can indicate that the query 102 is valid, or predicted to be factually true. In some examples, the prediction 152 can indicate that the query 102 is not valid, or predicted to be factually incorrect.

A verified query can include a query that was predicted to be factually true. For example, the system 100 can determine that the query 102 is verified if the prediction 152 indicates that the query 102 is valid.

The system 100 receives the query 102 that includes natural language text for verification. For example, the query 102 can include a claim, also referred to as a statement. In the example of FIG. 1A, the query includes the text “La Rochelle is situated on the west coast of France.”

In some examples, the system 100 receives the query 102 from a user. For example, the query 102 can include a statement shared on the Internet. For example, the system 100 can receive the query 102 from a user through a user interface of a user device.

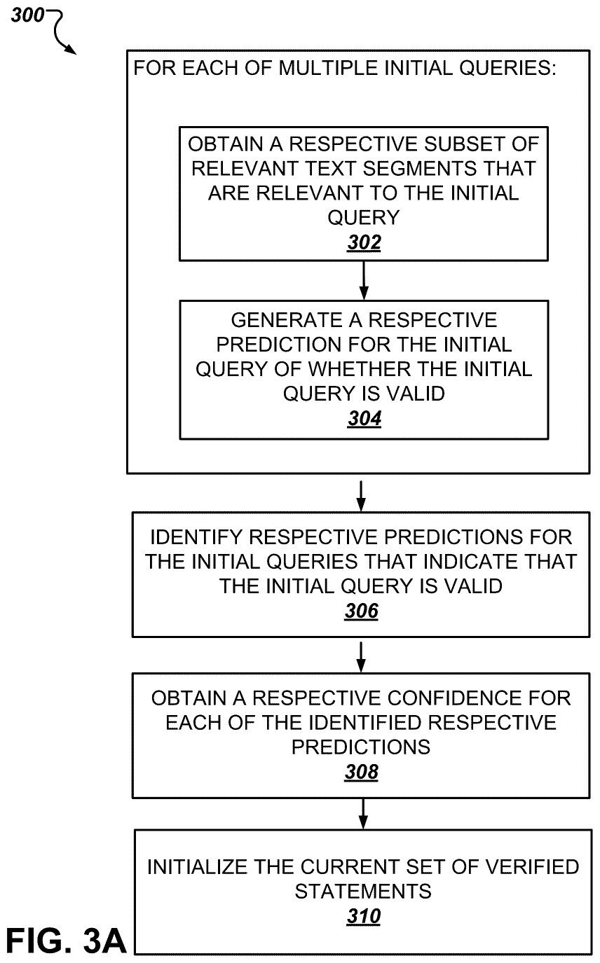

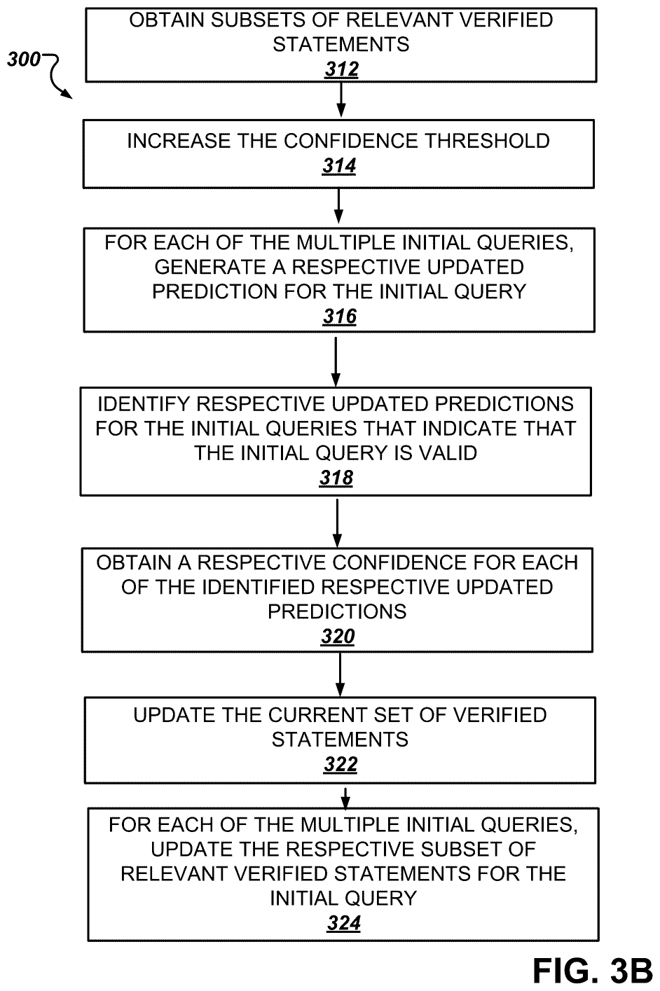

In some examples, the system 100 obtains the query 102 from a set of one or more queries to be verified. For example, the system 100 can obtain the set of queries to be verified from one or more text segments, e.g., from a collection of information such as the Internet. As an example, the system can generate the set of queries to be verified similarly to generating initial queries as described below with reference to FIG. 3B. The system 100 can thus identify queries to be verified for automating fact-checking of a collection of information.

The system 100 can obtain, from a set of text segments 110, a subset of relevant text segments 132 that are relevant to the query. The text segments 110 can include documents such as webpages, or paragraphs from the documents.

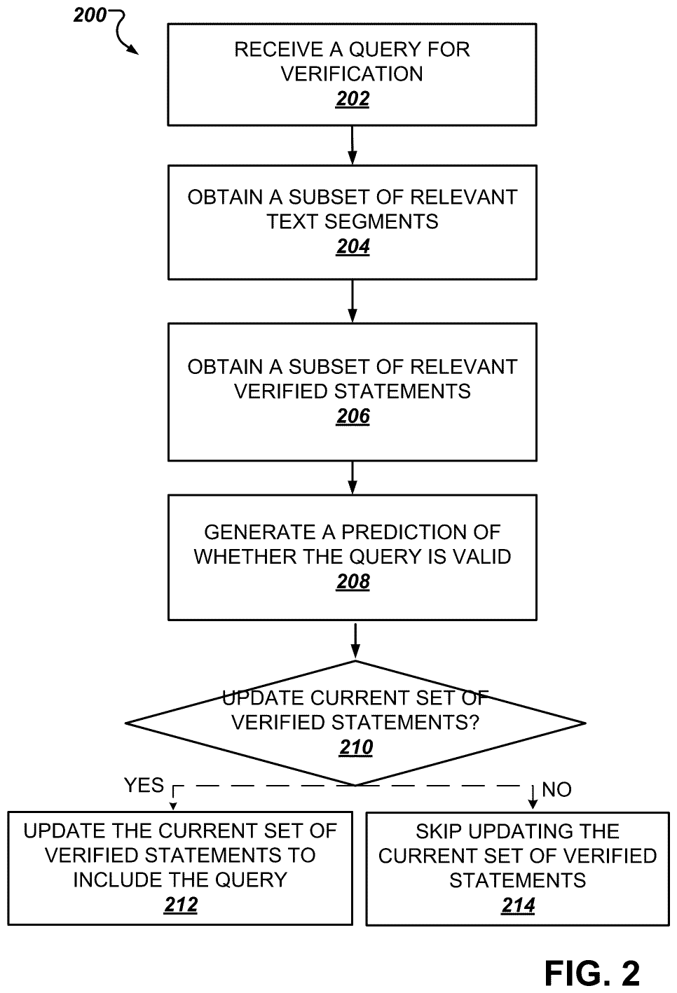

As an example, the system can obtain the subset of relevant text segments 132 by providing the query 102 and the set of text segments 110 as input to a text segment retriever machine learning model 130. The text segment retriever machine learning model 130 can generate an output that identifies the subset of relevant text segments 132 from the set of text segments 110 that are most relevant to the query 102. The text segment retriever machine learning model 130 is described in further detail below with reference to FIG. 2.

The system 100 can obtain, from a current set of verified statements 120, a subset of relevant verified statements 142 that are relevant to the query 102. Each verified statement can be a statement that was predicted to be valid. For example, each particular verified statement can have been predicted to be valid as described in FIGS. 3A-3B, or can have been a query that was predicted to be valid by the system 100. In some examples, each verified statement can be a ground-truth valid statement.

As an example, the system can obtain the subset of relevant verified statements 142 by providing the query 102 and the current set of verified statements 120 as input to a statement retriever machine learning model 140. The statement retriever machine learning model 140 can generate an output that identifies the subset of relevant verified statements 142 from the current set of verified statements 120 that are most relevant to the query 102. The statement retriever machine learning model 140 is described below in further detail with reference to FIG. 2.

In some examples, the system can determine the current set of verified statements 120 from initial queries. Determining the current set of verified statements 120 is described in further detail below with reference to FIGS. 3A-3B.

The system 100 can generate a prediction 152 of whether the query is valid given the relevant text segments 132 and the relevant verified statements 142. In some examples, the prediction 152 can include text that indicates whether the query 102 is valid. In the example of FIG. 1A, the prediction 152 can include the text “True,” indicating a prediction that the query 102 is valid. In some examples, the prediction 152 can include a confidence score indicating a confidence that the query 102 is valid. For example, the confidence score can be based on the probability assigned to a token that indicates that the query 102 is valid, e.g., “T”, during decoding by the query verifier machine learning model 150. In some examples, a confidence score that meets a threshold confidence score can indicate a prediction that the query 102 is valid.

For example, the system 100 can provide the query 102, relevant text segments 132, and the relevant verified statements 142 as input to a query verifier machine learning model 150. The query verifier machine learning model 150 can include a neural network that is configured to generate a prediction of whether the input query is valid conditioned on relevant text segments and relevant verified statements. The query verifier machine learning model 150 is also referred to as a conditional model, as the query verifier machine learning model 150 is conditioned on statements. An example query verifier machine learning model 150 is described in further detail below with reference to FIG. 1B.

The system 100 can further process the query 102 based on the prediction 152 of whether the query is valid. For example, the system 100 can provide data representing the prediction 152 for presentation on a user device. As a particular example, if the prediction 152 indicates that the query 102 is valid, the system 100 can provide data representing the text “True” for presentation. As another example, if the prediction 152 indicates that the query 102 is valid, the system 100 can provide data representing the text “False” for presentation.

As another example, if the prediction 152 indicates that the query 102 is valid, the system 100 can process the query 102 for a downstream task. Examples of downstream tasks include a natural language processing (NLP) task, i.e., receive input data that includes text and process the input data to generate a sequence of text responsive to the input data, such as question answering, sentence completion, reasoning, etc.

As a particular example, the system can maintain data representing the current set of verified statements in a database for later reference for a language processing task. In response to receiving a question, the system can query the current set of verified statements to generate an answer to the question, e.g., using a language model neural network. For example, the system can receive a question about the identity of the leader of an institution. The system can process an input that includes at least some of the current set of verified statements and the question using a language model neural network to generate an answer to the question. In some examples, the system can select the verified statements of the input as statements that are relevant to the question.

The system 100 can determine whether to update the current set of verified statements 120 to include the query 102 based on the prediction 152 of whether the query is valid. For example, if the prediction 152 indicates that the query 102 is valid, the system 100 can add the query 102 to the current set of verified statements 120. In the example of FIG. 1A, the system 100 can determine to update the current set of verified statements 120 to include “La Rochelle is situated on the west coast of France” based on the prediction 152 that includes “True.”

Upon receiving a subsequent query for verification, the system can use the updated current set of verified statements 120 to verify the subsequent query.

FIG. 1B shows the example query verifier machine learning model 150 of FIG. 1A. The query verifier machine learning model 150 can include an encoder 160 and a decoder 170.

The query verifier machine learning model 150 can have any appropriate architecture for generating a prediction of whether an input query is valid. For example, the query verifier machine learning model 150 can include an encoder and a decoder. In some examples, the encoder and decoder can be initialized from the encoder and decoder of a language model neural network with a Transformer-based architecture, e.g., a T5 model.

In general a Transformer-based architecture can be one which is characterized by having a succession of self-attention neural network layers. A self-attention neural network layer has an attention layer input for each element of the input and is configured to apply an attention mechanism over attention layer inputs to generate an attention layer output for each element of the input. There are many different attention mechanisms that may be used.

Examples of such architectures include those described in Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv:1910.10683, 2019.

The language model neural network can be configured to generate output sequences made up of tokens from a vocabulary. In some examples, the vocabulary of tokens can include any of a variety of tokens that represent text symbols or other symbols. For example, the vocabulary of tokens can include one or more of characters, sub-words, words, punctuation marks, numbers, or other symbols that appear in a corpus of natural language text and/or computer code.

Additionally, or alternatively, the vocabulary of tokens can include tokens that can represent data other than text, such as images, videos, or audio. For example, the vocabulary of tokens can include image tokens that represent a discrete set of image patch embeddings of an image that can be generated by an image encoder neural network based on processing the image patches of the image. As another example, the vocabulary of tokens can include audio tokens that represent code vectors in a codebook of a quantizer, e.g., a residual vector quantizer.

As a particular example, the query verifier machine learning model 150 can have a T5-based Fusion-In-Decoder architecture, as described in Izacard et al., Leveraging passage retrieval with generative models for open domain question answering, Conference of the European Chapter of the Association for Computational Linguistics, 2020.

In some examples, the query verifier machine learning model 150 can have been trained, e.g., fine-tuned, on a training dataset that includes multiple training examples. Each training example can include a training input that includes a statement, and one or more relevant statements, one or more relevant text segments, or both. Each training example can include a corresponding target output that represents a prediction of whether the statement is valid. The query verifier machine learning model 150 can have been trained to minimize a softmax cross-entropy loss between the target output and the prediction generated by the query verifier machine learning model 150 for the training input.

FIG. 1B shows the example query verifier machine learning model 150 processing multiple text segments, multiple statements, and a query. For example, the query verifier machine learning model 150 can process relevant text segments 132a-n of the subset of relevant text segments 132, multiple statements 142a-m of the subset of relevant verified statements 142, and the query 102.

For each relevant text segment 132a-n, the query verifier machine learning model 150 can process the query 102 combined, e.g., concatenated, with the relevant text segment to generate a respective encoding 162a-n for the relevant text segment. For example, the query verifier machine learning model 150 can process the query 102 and the relevant text segment 132a using the encoder 160 to generate the encoding 162a for the relevant text segment 132a.

In some examples, the query verifier machine learning model 150 can include special tokens before the query and each relevant text segment.

For each relevant verified statement 142a-m, the query verifier machine learning model 150 can process the query 102 combined, e.g., concatenated, with the relevant verified statement to generate a respective encoding 164a-m for the relevant verified statement. For example, the query verifier machine learning model 150 can process the query 102 and the relevant verified statement 142a using the encoder 160 to generate the encoding 164a for the relevant verified statement 142a.

In some examples, the query verifier machine learning model 150 can include special tokens before the query and each relevant verified statement.

The query verifier machine learning model 150 can generate a decoder input 168 from the respective encodings 162a-n for the relevant text segments and the respective encodings 164a-m for the relevant verified statements. For example, the query verifier machine learning model 150 can concatenate the respective encodings 162a-n and the respective encodings 164a-m. As a particular example, the system 100 can concatenate the respective encodings 162a-n and the respective encodings 164a-m sequentially.

The query verifier machine learning model 150 can process the decoder input 168 using the decoder 170 to generate an output token 172. The output token 172 represents the prediction of whether the query 102 is valid. For example, the output token can include the token “T” representing “True,” or a prediction that the query 102 is valid. As another example, the output token can include the token “F” representing “False,” or a prediction that the query 102 is not valid.

For example, the query verifier machine learning model can be an auto-regressive neural network that auto-regressively generates an output sequence of tokens by generating each particular token in the output sequence conditioned on the decoder input 168 and any tokens that precede the particular token in the output sequence.

More specifically, to generate a particular token at a decoding step, the decoder 170 can process the current input sequence and the decoder input 168 to generate a score distribution, e.g., a probability distribution, that assigns a respective score, e.g., a respective probability, to each token in the vocabulary of tokens. The query verifier machine learning model can then select, as the particular text token, a text token from the vocabulary using the score distribution. For example, the query verifier machine learning model can greedily select the highest-scoring token or can sample, e.g., using top-k sampling, nucleus sampling or another sampling technique, a token from the distribution.

The system can obtain the respective confidence for the output token 172 using the probability assigned to the output token 172 by the decoder 170.

The query verifier machine learning model 150 can thus generate the output token 172 according to TV=θc(query, topPsgs, GTR (query, CRS)), where TV is the output token 172, θc is the query verifier machine learning model 150, query is the query 102, topPsgs is the subset of text segments 132, and GTR(query,CRS) is the subset of relevant verified statements 142. For example, GTR can denote the text segment retriever machine learning model 130, and CRS is the current set of verified statements.

FIG. 2 is a flow diagram of an example process 200 for verifying a query. For convenience, the process 200 will be described as being performed by a system of one or more computers located in one or more locations. For example, a system for verifying queries, e.g., the system 100 of FIG. 1A, appropriately programmed, can perform the process 200.

The system receives a query for verification (202). The query can include natural language text.

The system obtains a subset of relevant text segments (204). The subset of relevant text segments can include text segments from a set of text segments that are relevant to the query.

For example, the system can provide the query and the set of text segments as input to a retriever machine learning model that is configured to generate an output that identifies a subset of relevant text segments from the set of text segments that are most relevant to the query.

In some examples, each text segment in the set of text segments can include a passage of text derived from multiple documents. For example, each passage can include a sequence of text tokens of a webpage.

The text segment retriever machine learning model can be implemented in any of a variety of possible ways. For example, the text segment retriever machine learning model can encode the query and the text segments as respective embeddings, and return, as the most relevant text segments, K of the text segments that have the closest embeddings to the embedding of the query.

For example, the retriever machine learning model 130 can generate embeddings for the query and the text segments using one or more encoders. Throughout this specification, an embedding refers to an ordered collection of numerical values, e.g., a vector or matrix of numerical values.

In some examples, each encoder can be initialized from the encoder of a language model neural network with a Transformer-based architecture.

As a particular example, the text segment retriever machine learning model can have a dual encoder architecture. The text segment retriever machine learning model can include an encoder that processes the query to generate a query embedding and an encoder that processes the text segments to generate a text segment embedding for each text segment. The text segment retriever machine learning model can determine a similarity measure, e.g., based on cosine similarity or dot product similarity, for the query embedding and each text segment embedding. The text segment retriever machine learning model can retrieve the K text segments that have a similarity measure that indicates the highest similarity to the query (e.g., lowest cosine distance). An example suitable architecture is described in further detail in Ni et al., Large dual encoders are generalizable retrievers, arXiv preprint arXiv:2112.07899, 2021.

In some examples, the retriever machine learning model 130 can have been trained, e.g., fine-tuned, on a training dataset of query-text segment pairs using a softmax loss that is based on the cosine similarity between the embeddings of the query and the text segments.

The system obtains a subset of relevant verified statements (206). The subset of relevant verified statements can include verified statements from a current set of verified statements that are relevant to the query.

For example, the system can provide the query and the current set of verified statements as input to a statement retriever machine learning model, also referred to as a second retriever machine learning model, that is configured to generate an output that identifies a subset of relevant verified statements from the current set of verified statements that are most relevant to the query.

In some examples, the current set of verified statements can include ground-truth verified statements. In some examples, the current set of verified statements can have been generated as described with reference to FIGS. 3A-3B.

The statement retriever machine learning model can be implemented in any of a variety of possible ways. For example, the retriever machine learning model can encode the query and the current set of verified statements as respective embeddings, and return, as the most relevant verified statements, K of the verified statements that have the closest embeddings to the embedding of the query.

For example, the statement retriever machine learning model can have a similar architecture as the text segment retriever machine learning model described above.

In some examples, the statement retriever machine learning model can have been trained, e.g., fine-tuned, on a training dataset of pairs of queries and related statements using a softmax cross-entropy loss that is based on the cosine similarity between the embeddings of the query and the statements.

The system generates a prediction of whether the query is valid (208). For example, the system can generate the prediction of whether the query is valid using a query verifier machine learning model given the relevant text segments and the relevant verified statements. As an example, the prediction can include a token such as “T” or “True” that indicates that the query is valid. As another example, the prediction can include a token such as “F” or “False” that indicates that the query is not valid. In some examples, the prediction can include a confidence score indicating whether the query is valid. For example, the system can determine that the prediction is valid if the confidence score meets a threshold. In some examples, the threshold can be a predetermined threshold. In some examples, the confidence score can be a confidence for the prediction as described below with reference to FIG. 3, and the threshold can be a confidence threshold as described below with reference to FIG. 3.

In some examples, the system can provide data representing the prediction for presentation on a user device. As a particular example, if the prediction indicates that the query is valid, the system can provide data representing the text “True” for presentation. As another example, if the prediction indicates that the query is not valid, the system can provide data representing the text “False” for presentation.

In some examples, if the prediction indicates that the query is valid, the system can process the query for a downstream task. Examples of downstream tasks include NLP tasks such as question answering, sentence completion, reasoning, etc.

The system determines whether to update the current set of verified statements (210). For example, the system can determine whether to update the current set of verified statements to include the query based on the prediction of whether the query is valid.

If the system determines that the prediction indicates that the query is valid, the system updates the current set of verified statements to include the query (212). In some examples, the system can determine that the prediction indicates that the query is valid in response to determining that the prediction includes a token such as “T” or “True”. In some examples, the system can determine that the prediction indicates that the query is valid in response to determining that the confidence score meets a threshold. For example, the system can update the current set of verified statements to include the query in response to determining that the confidence score meets a threshold.

If the system determines that the prediction indicates that the query is not valid, the system skips updating the current set of verified statements (214).

The system can repeat the process 200 for one or more further queries. Thus, in some examples, upon receipt of a further query for verification, the system can perform the process 200 using the current set of verified statements that has been updated to include one or more previous queries.

In examples where the system determines the current set of verified statements from initial queries, the system can process the initial queries using a first neural network, the text segment retriever machine learning model, the statement retriever machine learning model, and the query verifier machine learning model to initialize the current set of verified statements. After the system determines the current set of verified statements, the system can verify a received query based on the current set of verified statements. If the system determines that the received query is valid, the system can update the current set of verified statements to include the received query. The system can use the updated current set of verified statements to verify subsequent queries without having to re-initialize the current set of verified statements from initial queries.

FIGS. 3A-3B are a flow diagram of an example process 300 for determining a current set of verified statements. For convenience, the process 300 will be described as being performed by a system of one or more computers located in one or more locations. For example, a system for verifying queries, e.g., the system 100 of FIG. 1A, appropriately programmed, can perform the process 300.

The system can perform the process 300 to maximize _{CRS}^{argmax}Σᵢ[p_{θc}(TVᵢ|queryᵢ, topPsgᵢ, GTR(queryᵢ, CRS))], where CRS is the current set of verified statements, queryᵢ is an initial query of multiple initial queries, TVᵢ is the prediction for the initial query i, topPsgᵢ is the subset of relevant text segments that are relevant to the initial query, and GTR(queryᵢ, CRS) is the subset of relevant verified statements that are relevant to the initial query i.

Referring to FIG. 3A, the system performs the steps 302-304 for each of multiple initial queries i to generate predictions for each initial query according to TVᵢ←θu(queriesᵢ, topPsgsᵢ) for all i.

The system obtains a respective subset of relevant text segments that are relevant to the initial query (302). For example, the system obtains the respective subset of relevant text segments topPsgsᵢ from the set of text segments.

The system generates a respective prediction for the initial query of whether the initial query is valid (304). For example, the system can process the initial query and the respective subset of relevant text segments using a first neural network θu.

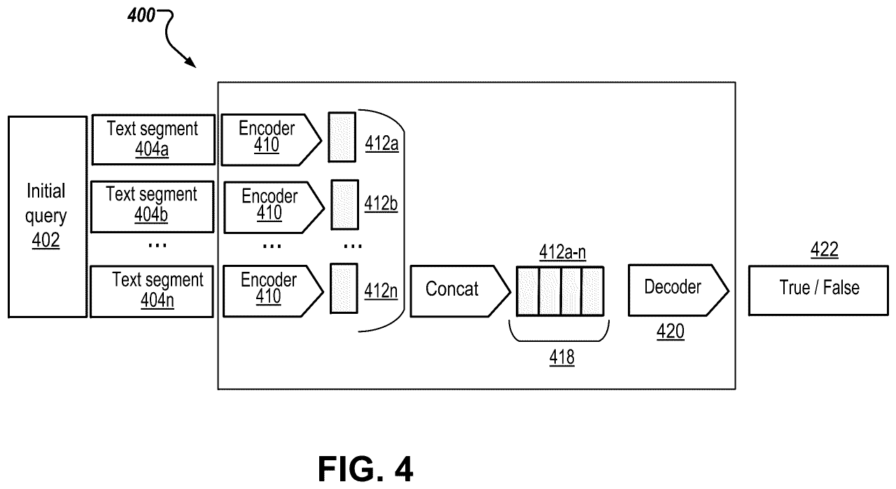

The first neural network can be configured to generate a prediction of whether an input query is valid conditioned on relevant text segments. The first neural network is also referred to as an independent or unconditional model, as the first neural network is not conditioned on statements. The first neural network is described in further detail below with reference to FIG. 4.

The system identifies respective predictions for the initial queries that indicate that the initial query is valid (306). In some examples, the system can identify predictions that include the token “T.”

The system obtains a respective confidence for each of the identified respective predictions (308). For example, the system can obtain the respective confidence for the token for a prediction using the probability assigned to the token “T” during decoding by the first neural network.

For example, to generate a particular token, at each of one or more decoding steps, the first neural network can assign a respective score, e.g., a respective probability, to each token in a vocabulary of tokens. The system can obtain the respective confidence for the token for the prediction using the respective score assigned to the token “T.”

The system initializes the current set of verified statements (310). For example, the system can initialize the current set of verified statements to include initial queries from the multiple initial queries for which the respective confidence for the identified respective prediction meets a confidence threshold. For example, the system can initialize the current set of verified statements as CRS←top cr of predicted T queries from TVᵢ, where cr is the confidence threshold. In some examples, the confidence threshold can be a predetermined confidence threshold.

Referring to FIG. 3B, in some implementations, the system can obtain, for each of the multiple initial queries, and from the current set of verified statements, a respective subset of relevant verified statements that are relevant to the initial query (312).

For example, the system can provide the initial query and the current set of verified statements as input to the second retriever machine learning model. For example, for each initial query i, the system can obtain the respective subset of relevant verified statements topStatementsᵢ using the second retriever machine learning model GTR and the current set of verified statements CRS according to topStatementsᵢ←GTR(queriesᵢ, CRS) for all i.

The system performs the steps 314-324 for each of multiple iterations. For example, the system can perform the steps 314-324 while the confidence meets a maximum confidence threshold. For example, the system can perform the steps 314-324 while the confidence is less than a maximum confidence threshold of 1.0.

The system increases the confidence threshold (314). For example, the system can increase the confidence threshold cr by a predetermined increment cr_{increment} according to cr←cr+cr_{increment}.

For each of the multiple initial queries, the system generates a respective updated prediction for the initial query (316). The system can process the initial query, the respective subset of relevant text segments for the initial query, and the respective subset of relevant verified statements for the initial query using the query verifier machine learning model. For example, the system can generate the respective updated prediction for each initial query i according to TVᵢ←θc(queriesᵢ, topPsgsᵢ, topStatementsᵢ) for all i.

The system identifies respective updated predictions for the initial queries that indicate that the initial query is valid (318). For example, the system can identify predictions that include the token “T.”

The system obtains a respective confidence for each of the identified respective updated predictions (320). For example, the system can obtain the respective confidence for the token of a prediction using the probability assigned to the token during decoding by the query verifier machine learning model.

For example, to generate a particular token, at each of one or more decoding steps, the query verifier machine learning model can assign a respective score, e.g., a respective probability, to each token in a vocabulary of tokens. The system can obtain the respective confidence for the token for the prediction using the respective score assigned to the token “T.”

The system updates the current set of verified statements (322). The system can update the current set of verified statements to include initial queries from the multiple initial queries for which the respective confidence for the identified respective updated prediction meets the confidence threshold. For example, the system can update the current set of verified statements according to CRS←top cr of predicted T queries from TVᵢ, where cr is the confidence threshold.

For each of the multiple initial queries, the system updates the respective subset of relevant verified statements for the initial query (324).

For example, the system can provide the initial query and the current set of verified statements as input to the second retriever machine learning model. For example, for each initial query i, the system can obtain the respective subset of relevant verified statements topStatementsᵢ using the second retriever machine learning model GTR and the current set of verified statements CRS according to topStatementsᵢ←GTR(queriesᵢ, CRS) for all i.

The system can update the current set of verified statements using the updated respective subsets of relevant verified statements for each initial query and the respective subset of relevant text segments for the initial query. For example, for each of the initial queries, the system can generate a respective second updated prediction for the initial query by processing the initial query, the respective subset of relevant text segments for the initial query, and the respective subset of relevant verified statements for the initial query using the query verifier machine learning model. For example, the system can generate the respective updated prediction for each initial query according to TVᵢ←θc(queriesᵢ, topPsgsᵢ, topStatementsᵢ) for all i.

The system can thus update the current set of verified statements to include initial queries from the multiple initial queries for which the respective second updated prediction indicates that the initial query is valid. The system can use the updated current set of verified statements as the current set of verified statements for verifying the query as described above with reference to FIGS. 1A-2.

In some examples, at least a subset of the multiple initial queries is obtained from a user. For example, the system can receive the subset of the multiple initial queries from the user through a user interface of a user device.

In some examples, the system can generate one or more of the multiple initial queries from source passages of text. For example, for each source passage, the system can identify the entities referenced in the source passage, e.g., using entity linking. The system can generate questions about the source passage. For example, the system can use a language model neural network to generate a question about the source passage where the answer includes an entity referenced in the source passage. In some examples, the language model neural network can have been trained to generate a natural question given the natural answer and source document. The system can filter the generated question and source passage using a question answering module, e.g., a language model neural network, to generate an answer to the question. For example, the system can filter out the generated question and answer if the answer generated does not match the original answer that was used to generate the question. The system generates an initial query using the generated question and answer. For example, the system processes the question, answer, and an instruction to rewrite the question and answer into a statement.

In some examples, the system validates the initial query. For example, the system processes the question and the initial query using a question answering model to generate a second answer. The system filters out initial queries for which the generated second answer does not match the original answer. In some examples, the system filters out ambiguous initial queries. For example, the system processes the initial query and an instruction to determine whether the query is ambiguous using a language model neural network. In some examples, the system filters the initial queries using entity linking, e.g., by filtering out initial queries for which every entity in the initial query does not appear in the source passage. In some examples, the system filters the initial queries using a retriever machine learning model. For example, the system can use the first retriever machine learning model described above given an initial query to filter out the initial query if the source passage is not in the subset of relevant text segments for the initial query. In some examples, the system generates negative statements using the initial query. For example, the system can use entity linking to identify an entity in the initial query. The system can replace the entity with another entity, e.g., selected from an ontology such as the Freebase ontology.

FIG. 4 shows an example first neural network 400. In examples where the system 100 described above with reference to FIG. 1A determines the current set of verified statements from initial queries, the system can process the initial queries using the first neural network 400, the text segment retriever machine learning model, the statement retriever machine learning model, and the query verifier machine learning model to determine the current set of verified statements.

The first neural network 400 can include an encoder 410 and a decoder 420.

FIG. 4 shows the example first neural network 400 processing multiple text segments, and a query. For example, the first neural network 400 can process an initial query 402 and relevant text segments 404a-n to the initial query 402.

For each relevant text segment 404a-n, the first neural network 400 can process the initial query 402 combined, e.g., concatenated, with the relevant text segment to generate a respective encoding 412a-n for the relevant text segment. For example, the first neural network 400 can process the initial query 402 and the relevant text segment 404a using the encoder 410 to generate the encoding 412a for the relevant text segment 404a.

The first neural network 400 can generate a decoder input 418 from the respective encodings 412a-n for the relevant text segments. For example, the first neural network 400 can concatenate the respective encodings 412a-n sequentially.

The first neural network 400 can process the decoder input 418 using the decoder 420 to generate an output token 422. The output token 422 represents the prediction of whether the initial query 402 is valid. For example, the output token can include the token “T” representing “True,” or a prediction that the query 402 is valid. As another example, the output token can include the token “F” representing “False,” or a prediction that the initial query 402 is not valid. For example, the first neural network can be an auto-regressive neural network that auto-regressively generates an output sequence of tokens by generating each particular token in the output sequence conditioned on the decoder input 418 and any tokens that precede the particular token in the output sequence.

More specifically, to generate a particular token at a decoding step, the decoder 420 can process the current input sequence and the decoder input 418 to generate a score distribution, e.g., a probability distribution, that assigns a respective score, e.g., a respective probability, to each token in the vocabulary of tokens. The first neural network can then select, as the particular text token, a text token from the vocabulary using the score distribution. For example, the first neural network can greedily select the highest-scoring token or can sample, e.g., using top-k sampling, nucleus sampling or another sampling technique, a token from the distribution.

The system can obtain the respective confidence for the output token 422 using the probability assigned to the output token 422 by the decoder 420.

The first neural network 400 can thus generate the output token 422 according to TV=Bu(query, topPsgs), where TV is the output token 422, Bu is the first neural network 400, queryis the query 402, and topPsgs is the subset of text segments 404a-n.

In some examples, the first neural network 400 can have been trained, e.g., fine-tuned, on a training dataset that includes multiple training examples. Each training example can include a training input that includes a statement and one or more relevant text segments. Each training example can include a corresponding target output that represents a prediction of whether the statement is valid. The first neural network 400 can have been trained to minimize a cross-entropy loss between the target output and the prediction generated by the first neural network 400 for the training input.

In some examples, the statements and one or more relevant text segments can have been obtained from a database of text segments organized by topic. For example, the system can use a language model neural network to obtain a statement from a text segment. The statement can include a rewritten sentence or sentence fragment from the text segment, or the negative of a sentence or sentence fragment from the text segment.

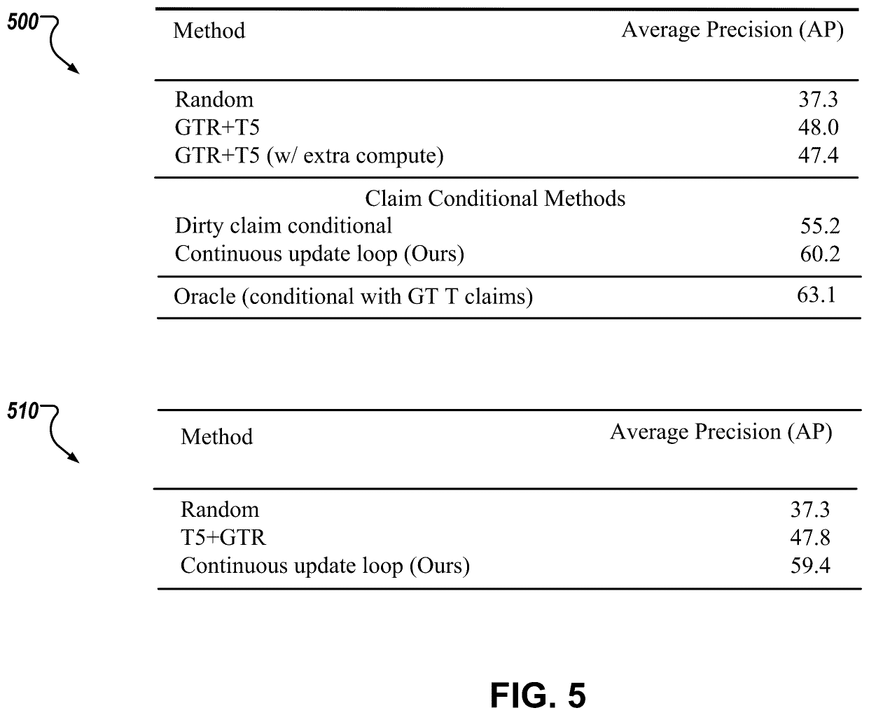

FIG. 5 shows the performance of an example system for verifying queries. In particular, FIG. 5 shows the performance of a variety of techniques for verifying queries in terms of average precision of true statements generated compared to false statements generated.

As can be seen from the table 500, the system described in this specification using a query verifier machine learning model (labeled as “Continuous update loop” in FIG. 5), achieves higher average precision compared to, e.g., an independent model, an independent model with additional compute, and using a current set of verified statements that includes ground-truth valid and false statements. The system described in this specification using a query verifier machine learning model achieves performance close to using a set of ground-truth valid statements.

The table 510 shows the performance of a variety of techniques for verifying queries using a training dataset of a smaller size than used for the table 500. The table 510 shows a small reduction for average precision, suggesting that performance as a function of training set size has plateaued and that an additional increase in training set size will likely not improve performance. Thus the system described in this specification can improve precision even in low data settings, allowing for reduced consumption of computing resources during gathering or generation of training data.

In this specification, the term “configured” is used in relation to computing systems and environments, as well as computer program components. A computing system or environment is considered “configured” to perform specific operations or actions when it possesses the necessary software, firmware, hardware, or a combination thereof, enabling it to carry out those operations or actions during operation. For instance, configuring a system might involve installing a software library with specific algorithms, updating firmware with new instructions for handling data, or adding a hardware component for enhanced processing capabilities. Similarly, one or more computer programs are “configured” to perform particular operations or actions when they contain instructions that, upon execution by a computing device or hardware, cause the device to perform those intended operations or actions.

The embodiments and functional operations described in this specification can be implemented in various forms, including digital electronic circuitry, software, firmware, computer hardware (encompassing the disclosed structures and their structural equivalents), or any combination thereof. The subject matter can be realized as one or more computer programs, essentially modules of computer program instructions encoded on a tangible non-transitory storage medium for execution by or to control the operation of a computing device or hardware. The storage medium can be a storage device such as a hard drive or solid-state drive (SSD), a storage medium, a random or serial access memory device, or a combination of these. Additionally or alternatively, the program instructions can be encoded on a transmitted signal, such as a machine-generated electrical, optical, or electromagnetic signal, designed to carry information for transmission to a receiving device or system for execution by a computing device or hardware. Furthermore, implementations may leverage emerging technologies like quantum computing or neuromorphic computing for specific applications, and may be deployed in distributed or cloud-based environments where components reside on different machines or within a cloud infrastructure.

The term “computing device or hardware” refers to the physical components involved in data processing and encompasses all types of devices and machines used for this purpose. Examples include processors or processing units, computers, multiple processors or computers working together, graphics processing units (GPUs), tensor processing units (TPUs), and specialized processing hardware such as field-programmable gate arrays (FPGAs) or application-specific integrated circuits (ASICs). In addition to hardware, a computing device or hardware may also include code that creates an execution environment for computer programs. This code can take the form of processor firmware, a protocol stack, a database management system, an operating system, or a combination of these elements. Embodiments may particularly benefit from utilizing the parallel processing capabilities of GPUs, in a General-Purpose computing on Graphics Processing Units (GPGPU) context, where code specifically designed for GPU execution, often called kernels or shaders, is employed. Similarly, TPUs excel at running optimized tensor operations crucial for many machine learning algorithms. By leveraging these accelerators and their specialized programming models, the system can achieve significant speedups and efficiency gains for tasks involving artificial intelligence and machine learning, particularly in areas such as computer vision, natural language processing, and robotics.

A computer program, also referred to as software, an application, a module, a script, code, or simply a program, can be written in any programming language, including compiled or interpreted languages, and declarative or procedural languages. It can be deployed in various forms, such as a standalone program, a module, a component, a subroutine, or any other unit suitable for use within a computing environment. A program may or may not correspond to a single file in a file system and can be stored in various ways. This includes being embedded within a file containing other programs or data (e.g., scripts within a markup language document), residing in a dedicated file, or distributed across multiple coordinated files (e.g., files storing modules, subprograms, or code segments). A computer program can be executed on a single computer or across multiple computers, whether located at a single site or distributed across multiple sites and interconnected through a data communication network. The specific implementation of the computer programs may involve a combination of traditional programming languages and specialized languages or libraries designed for GPGPU programming or TPU utilization, depending on the chosen hardware platform and desired performance characteristics.

In this specification, the term “engine” broadly refers to a software-based system, subsystem, or process designed to perform one or more specific functions. An engine is typically implemented as one or more software modules or components installed on one or more computers, which can be located at a single site or distributed across multiple locations. In some instances, one or more dedicated computers may be used for a particular engine, while in other cases, multiple engines may operate concurrently on the same one or more computers. Examples of engine functions within the context of AI and machine learning could include data pre-processing and cleaning, feature engineering and extraction, model training and optimization, inference and prediction generation, and post-processing of results. The specific design and implementation of engines will depend on the overall architecture and the distribution of computational tasks across various hardware components, including CPUs, GPUs, TPUs, and other specialized processors.

The processes and logic flows described in this specification can be executed by one or more programmable computers running one or more computer programs to perform functions by operating on input data and generating output. Additionally, graphics processing units (GPUs) and tensor processing units (TPUs) can be utilized to enable concurrent execution of aspects of these processes and logic flows, significantly accelerating performance. This approach offers significant advantages for computationally intensive tasks often found in AI and machine learning applications, such as matrix multiplications, convolutions, and other operations that exhibit a high degree of parallelism. By leveraging the parallel processing capabilities of GPUs and TPUs, significant speedups and efficiency gains compared to relying solely on CPUs can be achieved. Alternatively or in combination with programmable computers and specialized processors, these processes and logic flows can also be implemented using specialized processing hardware, such as field-programmable gate arrays (FPGAs) or application-specific integrated circuits (ASICs), for even greater performance or energy efficiency in specific use cases.

Computers capable of executing a computer program can be based on general-purpose microprocessors, special-purpose microprocessors, or a combination of both. They can also utilize any other type of central processing unit (CPU). Additionally, graphics processing units (GPUs), tensor processing units (TPUs), and other machine learning accelerators can be employed to enhance performance, particularly for tasks involving artificial intelligence and machine learning. These accelerators often work in conjunction with CPUs, handling specialized computations while the CPU manages overall system operations and other tasks. Typically, a CPU receives instructions and data from read-only memory (ROM), random access memory (RAM), or both. The elements of a computer include a CPU for executing instructions and one or more memory devices for storing instructions and data. The specific configuration of processing units and memory will depend on factors like the complexity of the AI model, the volume of data being processed, and the desired performance and latency requirements. Embodiments can be implemented on a wide range of computing platforms, from small embedded devices with limited resources to large-scale data center systems with high-performance computing capabilities. The system may include storage devices like hard drives, SSDs, or flash memory for persistent data storage.

Computer-readable media suitable for storing computer program instructions and data encompass all forms of non-volatile memory, media, and memory devices. Examples include semiconductor memory devices such as read-only memory (ROM), solid-state drives (SSDs), and flash memory devices; hard disk drives (HDDs); optical media; and optical discs such as CDs, DVDs, and Blu-ray discs. The specific type of computer-readable media used will depend on factors such as the size of the data, access speed requirements, cost considerations, and the desired level of portability or permanence.

To facilitate user interaction, embodiments of the subject matter described in this specification can be implemented on a computing device equipped with a display device, such as a liquid crystal display (LCD) or an organic light-emitting diode (OLED) display, for presenting information to the user. Input can be provided by the user through various means, including a keyboard), touchscreens, voice commands, gesture recognition, or other input modalities depending on the specific device and application. Additional input methods can include acoustic, speech, or tactile input, while feedback to the user can take the form of visual, auditory, or tactile feedback. Furthermore, computers can interact with users by exchanging documents with a user's device or application. This can involve sending web content or data in response to requests or sending and receiving text messages or other forms of messages through mobile devices or messaging platforms. The selection of input and output modalities will depend on the specific application and the desired form of user interaction.

Machine learning models can be implemented and deployed using machine learning frameworks, such as TensorFlow or JAX. These frameworks offer comprehensive tools and libraries that facilitate the development, training, and deployment of machine learning models.

Embodiments of the subject matter described in this specification can be implemented within a computing system comprising one or more components, depending on the specific application and requirements. These may include a back-end component, such as a back-end server or cloud-based infrastructure; an optional middleware component, such as a middleware server or application programming interface (API), to facilitate communication and data exchange; and a front-end component, such as a client device with a user interface, a web browser, or an app, through which a user can interact with the implemented subject matter. For instance, the described functionality could be implemented solely on a client device (e.g., for on-device machine learning) or deployed as a combination of front-end and back-end components for more complex applications. These components, when present, can be interconnected using any form or medium of digital data communication, such as a communication network like a local area network (LAN) or a wide area network (WAN) including the Internet. The specific system architecture and choice of components will depend on factors such as the scale of the application, the need for real-time processing, data security requirements, and the desired user experience.

The computing system can include clients and servers that may be geographically separated and interact through a communication network. The specific type of network, such as a local area network (LAN), a wide area network (WAN), or the Internet, will depend on the reach and scale of the application. The client-server relationship is established through computer programs running on the respective computers and designed to communicate with each other using appropriate protocols. These protocols may include HTTP, TCP/IP, or other specialized protocols depending on the nature of the data being exchanged and the security requirements of the system. In certain embodiments, a server transmits data or instructions to a user's device, such as a computer, smartphone, or tablet, acting as a client. The client device can then process the received information, display results to the user, and potentially send data or feedback back to the server for further processing or storage. This allows for dynamic interactions between the user and the system, enabling a wide range of applications and functionalities.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method comprising:
receiving a query comprising natural language text for verification;
obtaining, from a set of text segments, a subset of relevant text segments that are relevant to the query;
obtaining, from a current set of verified statements, a subset of relevant verified statements that are relevant to the query;
generating, using a query verifier machine learning model, a prediction of whether the query is valid given the relevant text segments and the relevant verified statements; and
determining whether to update the current set of verified statements to include the query based on the prediction of whether the query is valid.

2. The method of claim 1, wherein determining whether to update the current set of verified statements to include the query based on the prediction of whether the query is valid comprises:
determining that the prediction indicates that the query is valid, wherein the prediction includes a confidence score; and
in response to the confidence score meeting a threshold, updating the current set of verified statements to include the query.

3. The method of claim 1, wherein obtaining, from a set of text segments, a subset of relevant text segments that are relevant to the query comprises:
providing the query and the set of text segments as input to a text segment retriever machine learning model that is configured to generate an output that identifies a subset of relevant text segments from the set of text segments that are most relevant to the query.

4. The method of claim 1, wherein obtaining, from a current set of verified statements, a subset of relevant verified statements that are relevant to the query comprises:
providing the query and the current set of verified statements as input to a statement retriever machine learning model that is configured to generate an output that identifies a subset of relevant verified statements from the current set of verified statements that are most relevant to the query.

5. The method of claim 1, wherein the query verifier machine learning model is configured to:
for each relevant text segment, process the query concatenated with the relevant text segment to generate a respective encoding for the relevant text segment;
for each relevant verified statement, process the query concatenated with the relevant verified statement to generate a respective encoding for the relevant verified statement;
generate a decoder input from the respective encodings for the relevant text segments and the respective encodings for the relevant verified statements; and
process the decoder input using a decoder to generate an output token representing the prediction of whether the query is valid.

6. The method of claim 1, wherein the current set of verified statements is determined by:
for each of a plurality of initial queries:
obtaining, from the set of text segments, a respective subset of relevant text segments that are relevant to the initial query;
generating a respective prediction for the initial query of whether the initial query is valid by processing the initial query and the respective subset of relevant text segments using a first neural network;
identifying respective predictions for the initial queries that indicate that the initial query is valid;
obtaining a respective confidence for each of the identified respective predictions; and
initializing the current set of verified statements to include initial queries from the plurality of initial queries for which the respective confidence for the identified respective prediction meets a confidence threshold.

7. The method of claim 6, further comprising:
for each of the plurality of initial queries:
obtaining, from the current set of verified statements, a respective subset of relevant verified statements that are relevant to the initial query.

8. The method of claim 7, wherein obtaining, from a current set of verified statements, a subset of relevant verified statements that are relevant to the query comprises providing the query and the current set of verified statements as input to a statement retriever machine learning model that is configured to generate an output that identifies a subset of relevant verified statements from the current set of verified statements that are most relevant to the query, and wherein obtaining, from the current set of verified statements, a respective subset of relevant verified statements that are relevant to the initial query comprises providing the initial query and the current set of verified statements as input to the statement retriever machine learning model.

9. The method of claim 7, further comprising:
for each of a plurality of iterations:
increasing the confidence threshold;
for each of the plurality of initial queries:
generating a respective updated prediction for the initial query by processing the initial query, the respective subset of relevant text segments for the initial query, and the respective subset of relevant verified statements for the initial query using the query verifier machine learning model;
identifying respective updated predictions for the initial queries that indicate that the initial query is valid;
obtaining a respective confidence for each of the identified respective updated predictions;
updating the current set of verified statements to include initial queries from the plurality of initial queries for which the respective confidence for the identified respective updated prediction meets the confidence threshold; and
for each of the plurality of initial queries:
updating the respective subset of relevant verified statements for the initial query.

10. The method of claim 9, wherein obtaining, from a current set of verified statements, a subset of relevant verified statements that are relevant to the query comprises providing the query and the current set of verified statements as input to a statement retriever machine learning model that is configured to generate an output that identifies a subset of relevant verified statements from the current set of verified statements that are most relevant to the query, and wherein updating the respective subset of relevant verified statements for the initial query comprises providing the initial query and the current set of verified statements as input to the statement retriever machine learning model.

11. The method of claim 9, further comprising:
for each of the plurality of initial queries:
generating a respective second updated prediction for the initial query by processing the initial query, the respective subset of relevant text segments for the initial query, and the respective subset of relevant verified statements for the initial query using the query verifier machine learning model.

12. The method of claim 11, further comprising:
updating the current set of verified statements to include initial queries from the plurality of initial queries for which the respective second updated prediction indicates that the initial query is valid.

13. The method of claim 6, wherein at least a subset of the plurality of initial queries is obtained from a user.

14. The method of claim 6, wherein the first neural network is configured to:
for each relevant text segment, process the initial query concatenated with the relevant text segment to generate a respective encoding for the relevant text segment;
generate a decoder input from the respective encodings for the relevant text segments; and
process the decoder input using a first decoder to generate an output token representing the prediction of whether the initial query is valid.

15. A system comprising:
one or more computers; and
one or more storage devices storing instructions that, when executed by the one or more computers, cause the one or more computers to perform operations comprising:
receiving a query comprising natural language text for verification;
obtaining, from a set of text segments, a subset of relevant text segments that are relevant to the query;
obtaining, from a current set of verified statements, a subset of relevant verified statements that are relevant to the query;
generating, using a query verifier machine learning model, a prediction of whether the query is valid given the relevant text segments and the relevant verified statements; and
determining whether to update the current set of verified statements to include the query based on the prediction of whether the query is valid.

16. The system of claim 15, wherein determining whether to update the current set of verified statements to include the query based on the prediction of whether the query is valid comprises:
determining that the prediction indicates that the query is valid, wherein the prediction includes a confidence score; and
in response to the confidence score meeting a threshold, updating the current set of verified statements to include the query.

17. The system of claim 15, wherein obtaining, from a set of text segments, a subset of relevant text segments that are relevant to the query comprises:
providing the query and the set of text segments as input to a text segment retriever machine learning model that is configured to generate an output that identifies a subset of relevant text segments from the set of text segments that are most relevant to the query.

18. The system of claim 15, wherein obtaining, from a current set of verified statements, a subset of relevant verified statements that are relevant to the query comprises:
providing the query and the current set of verified statements as input to a statement retriever machine learning model that is configured to generate an output that identifies a subset of relevant verified statements from the current set of verified statements that are most relevant to the query.

19. The system of claim 15, wherein the query verifier machine learning model is configured to:
for each relevant text segment, process the query concatenated with the relevant text segment to generate a respective encoding for the relevant text segment;
for each relevant verified statement, process the query concatenated with the relevant verified statement to generate a respective encoding for the relevant verified statement;
generate a decoder input from the respective encodings for the relevant text segments and the respective encodings for the relevant verified statements; and
process the decoder input using a decoder to generate an output token representing the prediction of whether the query is valid.

20. One or more computer-readable storage media storing instructions that when executed by one or more computers cause the one or more computers to perform operations comprising:
receiving a query comprising natural language text for verification;
obtaining, from a set of text segments, a subset of relevant text segments that are relevant to the query;
obtaining, from a current set of verified statements, a subset of relevant verified statements that are relevant to the query;
generating, using a query verifier machine learning model, a prediction of whether the query is valid given the relevant text segments and the relevant verified statements; and
determining whether to update the current set of verified statements to include the query based on the prediction of whether the query is valid.
